(19) United States
(12) Patent Application Publication
(10) Pub. No.: US 2010/0245381 A1
(43) Pub. Date: Sep. 30, 2010

(54) COLOR GAMUT MAPPING

(76) Inventors: Ramin Samadani, Menlo Park, CA (US); Kar-Han Tan, Santa Clara, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/413,543

(22) Filed: Mar. 28, 2009

(51) Int. Cl. G09G 5/02

(52) U.S. Cl. 345/593

(57) ABSTRACT

For each of multiple image pixels, input color component values of the pixel in an input device-dependent color space are transformed to output color component values in an output device-dependent color space characterized by an output color gamut defined by a respective gamut range for each of the output color components. In this process, the input color component values of the pixel are multiplied with corresponding elements of a device-dependent characterization matrix to produce a set of product values. The output color component values are derived from the product values. The values of a particular one of the output color components are ascertained based on a continuous nonlinear companding function that maps a function input value derived from one or more of the product values to a function output value that increases monotonically with increasing function input values over the respective gamut range of the particular output color component.

### BACKGROUND OF THE INVENTION

Color gamut mapping typically involves translating the volumetric color range (i.e., “color gamut”) of an image source device (e.g., a camera or optical scanner) to the volumetric color range of an image destination device (e.g., a printer or a display). In this case, the color gamut mapping typically is designed to optimize the translation of the limited dynamic range of the image source device to the limited (and typically different) dynamic range of the image destination device. When the transformed colors of the input device are mapped to values that are outside the gamut of the target color space these colors oftentimes are scaled or clipped or otherwise transformed so that they fall within the gamut boundary.

Some color gamut mapping systems provide an interface that enables a user to manually control the mapping parameters in order to achieve a visually satisfactory result on the image destination device. Other gamut mapping systems map the color gamut of the image source device to a device-independent color space (e.g., the CIE XYZ color space) using a color management profile that is associated with the image source device. The device-independent color space then may be mapped to the color gamut of the image destination device using a color management profile that is associated with the image destination device.

### BRIEF SUMMARY OF THE INVENTION

In one aspect, the invention features a method in accordance with which, for each of multiple pixels of an image, values of input color components of the pixel in an input device-dependent color space are transformed to values of output color components in an output device-dependent color space characterized by an output color gamut defined by a respective gamut range for each of the output color components. In this process, the input color component values of the pixel are multiplied with corresponding elements of a device-dependent characterization matrix to produce a set of product values. The output color component values are derived from the product values. The values of a particular one of the output color components are ascertained based on a continuous nonlinear companding function that maps a function input value derived from one or more of the product values to a function output value that increases monotonically with increasing function input values over the respective gamut range of the particular output color component.

The invention also features apparatus operable to implement the inventive methods described above and computer-readable media storing computer-readable instructions causing a computer to implement the inventive methods described above.

Other features and advantages of the invention will become apparent from the following description, including the drawings and the claims.

### BRIEF DESCRIPTION OF THE DRAWINGS

FIG. 1 is a block diagram of an embodiment of a color transformer that performs color gamut mapping of an input image to an output image.

FIGS. 2A and 2B are three-dimensional graphs of different respective color spaces.

FIG. 3 is a flow diagram of an embodiment of a method of transforming values of input color components in an input device-dependent color space to values of output color components in an output device-dependent color space.

FIG. 4 is a block diagram of an embodiment of a color transformation processing chain that is implemented by an embodiment of the color transformer of FIG. 1.

FIG. 5 is a diagrammatic view of an embodiment of a characterization matrix.

FIG. 6 is a graph of an embodiment of a nonlinear companding function.

FIG. 7 is a flow diagram of an embodiment of a method of selecting a particular output color component for companding from a set of output color components.

FIG. 8 is a block diagram of an embodiment of a computer system that incorporates an embodiment of the color transformer of FIG. 1.

FIG. 9 is a block diagram of an embodiment of a light projection system that incorporates an embodiment of the color transformer of FIG. 1.

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

### I. DEFINITION OF TERMS

A “color gamut” refers to a subset of colors that can be represented in a certain context, such as within a given color space or by a particular color reproduction device.

A “color space” is model that describes the way of representing colors as tuples of numbers representing “color components” that define the dimensions of the color space. Most color spaces are represented by three or four color components. A “device-dependent” color space is a color space that is associated with a device-dependent mapping of the tuple values to an absolute color space. Exemplary device-dependent color spaces include the RGB color space and the CMYK color space. A “device-independent” color space is a color space in which colors are calorimetrically defined without reference to external factors. Exemplary device-independent color spaces include the CIE XYZ color space, the CIE LAB color space, and the sRGB color space.

The term “companding” means of or relating to the reduction in a range of values.

The term “linear” means of, relating to, resembling, or having a graph that is a line with a single slope.

The term “nonlinear” means of, relating to, resembling, or having a graph that is a curved line or a piecewise linear line with multiple slopes.

An “image” broadly refers to any type of visually perceptible content that may be rendered (e.g., printed, displayed, or projected) on a physical medium (e.g., a sheet of paper, a display monitor, or a viewscreen). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

A “computer” is a machine that processes data according to machine-readable instructions (e.g., software) that are stored on a machine-readable medium either temporarily or permanently. A set of such instructions that performs a particular task is referred to as a program or software program. A “server” is a host computer on a network that responds to requests for information or service. A “client” is a computer on a network that requests information or service from a server.

The term “machine-readable medium” refers to any medium capable carrying information that is readable by a machine (e.g., a computer). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

### II. INTRODUCTION

The embodiments that are described herein provide systems and methods of transforming from an input device-dependent color space to an output device-dependent color space. Some embodiments are designed to efficiently provide smooth transformations even when the transformation involves substantial rebalancing of the color primaries that otherwise would result in many extremely out of range colors without requiring significant memory and computational resources. Due to their efficient use of processing and memory resources, some of these embodiments may be implemented with relatively small and inexpensive components that have modest processing power and modest memory capacity. As a result these embodiments are highly suitable for incorporation into compact device environments that have significant size, processing, and memory constraints, including but not limited to portable telecommunication devices (e.g., a mobile telephone and a cordless telephone), a micro-projector, a personal digital assistant (PDA), a multimedia player, a game controller, a pager, image and video recording and playback devices (e.g., digital still and video cameras, VCRs, and DVRs), printers, portable computers, and other embedded data processing environments (e.g., application specific integrated circuits (ASICs)).

### III. COLOR GAMUT MAPPING

A. Introduction

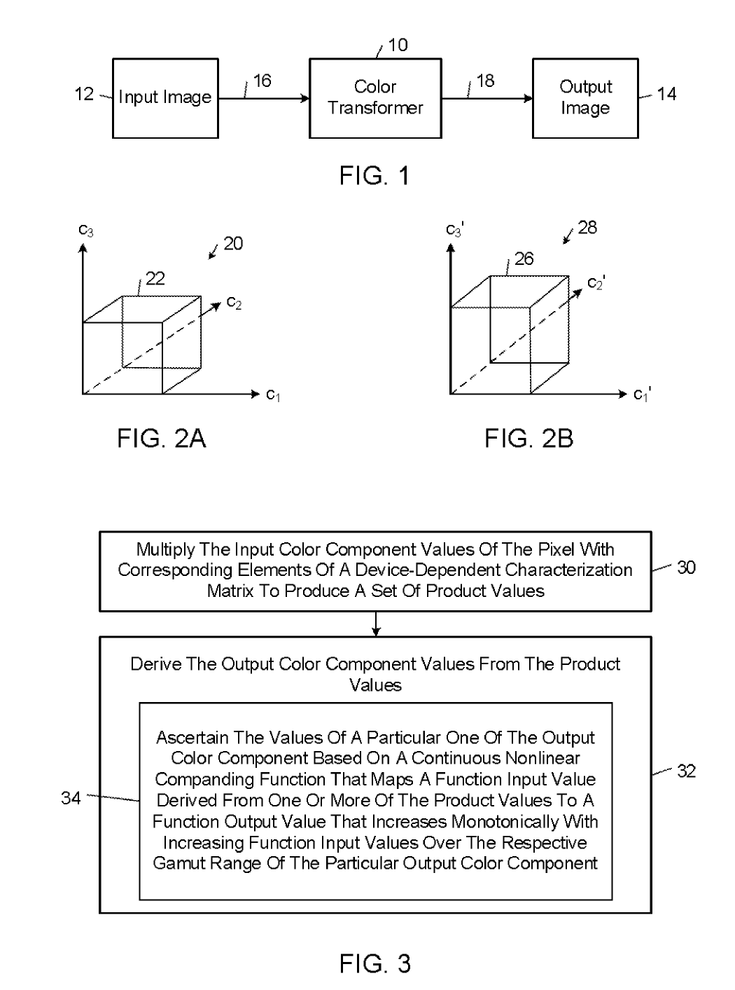

FIG. 1 shows an embodiment of a color transformer 10 that performs color gamut mapping of an input image 12 to an output image 14. In particular for each of multiple pixels of the input image 12, the color transformer 10 transforms values of input color components 16 of the pixel in an input device-dependent color space to values of output color components 18 in an output device-dependent color space.

FIG. 2A shows an exemplary device-dependent input color space 20 that is defined by a respective set of three color components c₁, c₂, and c₃. The input device-dependent color space 20 is characterized by an input color gamut 22, which is defined by a respective range for each of the input color components. FIG. 2B shows an exemplary device-dependent output color space 24 that is defined by a respective set of three color components c₁′, c₂′, and c₃′. The output device-dependent color space 24 is characterized by an output color gamut 26, which is defined by a respective range for each of the output color components.

Referring to FIG. 3, in the process of transforming the input color component values 16, the color transformer 10 multiplies the input color component values 16 of each pixel of the input image 12 with corresponding elements of a device-dependent characterization matrix to produce a set of product values (FIG. 3, block 30). The color transformer 10 derives the output color component values from the product values (FIG. 3, block 32). In this process, the color transformer 10 ascertains the values of a particular one of the output color components based on a continuous nonlinear companding function that maps a function input value derived from one or more of the product values to a function output value that increases monotonically with increasing function input values over the respective gamut range of the particular output color component (FIG. 3, block 34).

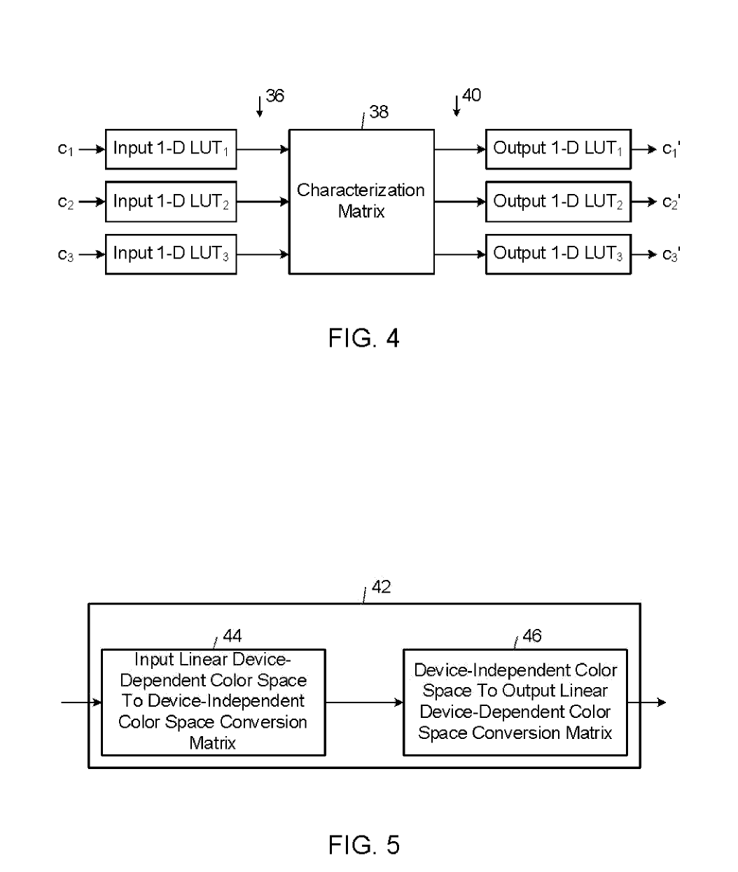

FIG. 4 is a block diagram of an embodiment of a color transformation processing chain that is implemented by an embodiment of the color transformer 10. In this embodiment, for each pixel of the input image 12, the color transformer 10 maps the values of the input color components c₁, c₂, and c₃ to intensity, which transforms the input color components values into respective color values 36 in a linearized version of the input color space. The color transformer 10 typically performs the linearization mapping of the input color components values using a respective one-dimensional lookup table (LUT) for each color component channel, as shown in FIG. 4. The color transformer 10 applies a characterization matrix 38 to the linear color values 36 in order to transform the color values 36 to respective color values 40 in a linearized version of the output color space. The color transformer 10 then maps the linear color values 40 to respective values of the output color components c₁l′, c₂′, and c₃′. The color transformer 10 typically performs the mapping of the linear colors values 40 to the output color components using a respective one-dimensional lookup table (LUT) for each color component channel, as shown in FIG. 4.

B. Characterization Matrix

In general, the characterization matrix 38 may be designed to perform any type of transformation between the respective device-dependent color spaces of the input image 12 and the output image 14. In some embodiments, the characterization matrix 38 solves the color management problem of translating color values in a color space of a first device into color values in a color space of a second device. In other embodiments, the characterization matrix 38 solves the inverse color management problem of estimating the color values that should be sent to a device (e.g., a printer or a light projector) in order to reproduce color values in a target color space.

FIG. 5 is a diagrammatic view of an embodiment 42 of the characterization matrix 38. In this embodiment, the characterization matrix 42 effectively implements in a single matrix a combination of a conversion of an input linear device-dependent color space to a device-independent color space (FIG. 5, block 44) and a conversion of a device-independent color space to an output linear device-dependent color space (FIG. 5, block 46). In some embodiments, the characterization matrix 42 effectively implements a combination of a conversion from an input linear RGB color space to the CIE XYZ color space and a conversion from the CIE XYZ color space to an output linear RGB color space.

C. Companding Function

In some embodiments, the companding function includes a linear mapping portion and a nonlinear mapping portion. The linear mapping portion maps function input values, which range from a minimal value of the respective gamut range of the particular output color component to a threshold value, to respective output values in accordance with a linear function. The nonlinear mapping portion maps function input values, which range from the threshold value to a maximal value of the respective gamut range of the particular output color component, in accordance with a nonlinear function.

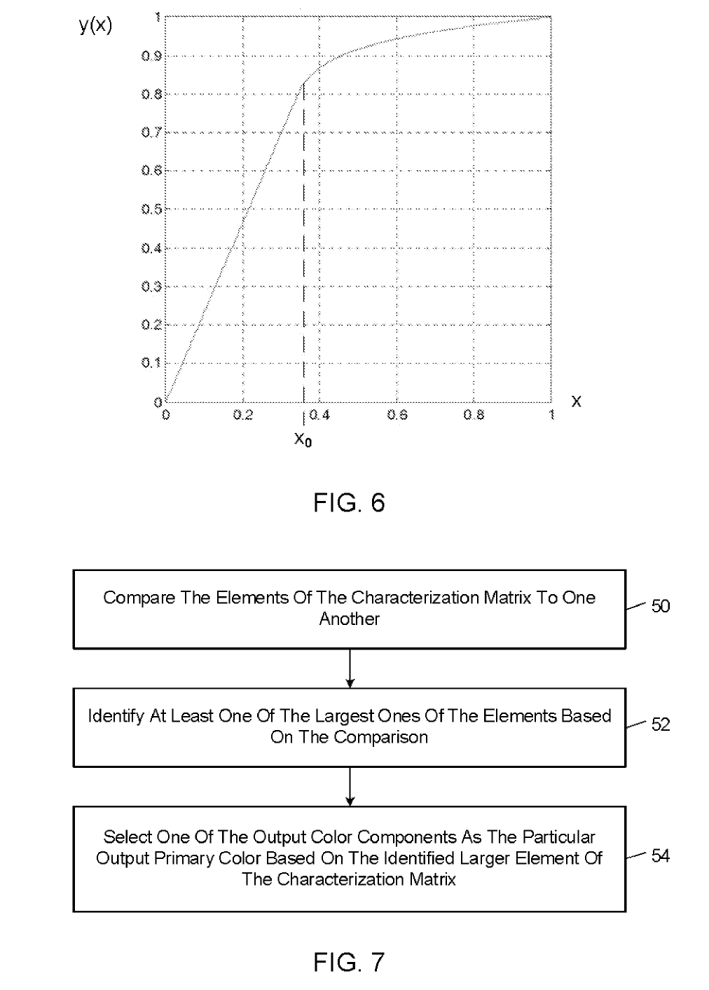

FIG. 6 shows an exemplary embodiment of a nonlinear companding function of this type. In this embodiment, the linear portion maps the function input values (x) less than the threshold value (x₀) to the function output values (y(x)) in accordance with y(x)=ax+b, and the nonlinear portion maps the function input values greater than the threshold to the function output values with a power function, as shown in equation (1):

$$y ( x ) = \{ \begin{matrix}a \cdot x + b & if x < {x}_{0} \\ \frac{{( x + k )}^{γ}}{( 1 + k )} & otherwise ,\end{matrix} \qquad ( 1 )$$

where a, b, k, and γ are constants, and a, k, and γ are greater than zero. In this embodiment, the parameter values of a, b, k, and γ are determined by matching the value and slope of the nonlinear power function shown in equation (1) to the value and the slope of the linear function at the threshold value x₀. This process typically involves specifying values for a, b, and x₀, and then setting the values of k and γ according to the matching constraints. In some embodiments, the values for a, b, and x₀ are fixed, empirically determined values; in other embodiments, they are set dynamically either manually by a user via an graphical user interface or automatically by a machine capable of setting these parameter values for the color transformer 10.

In some embodiments, the companding function defined in equation (1) is approximated by a piecewise linear function in order to reduce the computational resources required to compute the values in the varied slope portion.

D. Deriving Output Color Components from the Product Values

The characterization matrix 38 consists of matrix elements mᵢⱼ, where j has values that index the input color components and i has values that index the output color components. The elements of a 3×3 (i.e., i, jε[1,3]) characterization matrix M of this type are shown in equation (2):

$$M = ( \begin{matrix}{m}_{11} & {m}_{21} & {m}_{13} \\ {m}_{21} & {m}_{22} & {m}_{23} \\ {m}_{31} & {m}_{32} & {m}_{33}\end{matrix} ) \qquad ( 2 )$$

In the process of multiplying the input color component values 16 of each pixel of the input image 12 with corresponding elements of the characterization matrix (FIG. 3, block 30), the color transformer 10 produces a set of product values that are given by mᵢⱼ·cⱼ for all {i,j}, where cⱼ are the input color component values. In the case of the matrix M shown in equation (1), the result of the multiplying the input color component values 16 of a pixel of the input image 12 with corresponding elements of the characterization matrix M is shown in equation (3):

$$( \begin{matrix}{m}_{11} & {m}_{21} & {m}_{13} \\ {m}_{21} & {m}_{22} & {m}_{23} \\ {m}_{31} & {m}_{32} & {m}_{33}\end{matrix} ) ( \begin{matrix}{c}_{1} \\ {c}_{2} \\ {c}_{3}\end{matrix} ) = ( \begin{matrix}{m}_{11} \cdot {c}_{1} + {m}_{21} \cdot {c}_{2} + {m}_{13} \cdot {c}_{3} \\ {m}_{21} \cdot {c}_{1} + {m}_{22} \cdot {c}_{2} + {m}_{23} \cdot {c}_{3} \\ {m}_{31} \cdot {c}_{1} + {m}_{32} \cdot {c}_{2} + {m}_{33} \cdot {c}_{3}\end{matrix} ) , \qquad ( 3 )$$

The color transformer 10 derives the output color component values from the product values mᵢⱼ·cⱼ (FIG. 3, block 32). In this process, the color transformer 10 ascertains the values of a particular one of the output color components based on a continuous nonlinear companding function that maps a function input value derived from one or more of the product values to a function output value that increases monotonically with increasing function input values over the respective gamut range of the particular output color component (FIG. 3, block 34).

FIG. 7 is a flow diagram of an embodiment of a method of determining the particular output color component whose values are determined based on the companding function. In accordance with the method of FIG. 7, the elements of the characterization matrix are compared to one another (FIG. 7, block 50). At least one of the largest ones of the elements is identified based on the comparison (FIG. 7, block 52). One of the output color components is selected as the particular output color component based on the identified larger element of the characterization matrix (FIG. 7, block 54). In some embodiments, the particular one (or ones) of the output color components whose values are determined based on the companding function corresponds to the output color component whose values are derived from the element of the characterization matrix that has a maximal magnitude that is disproportionately large (e.g., by a factor of two or greater) in relation to the magnitudes of the other diagonal matrix elements. In general, the particular one (or ones) of the output color components whose values are determined based on the companding function may be fixed (e.g., determined during manufacture or calibration of a device) or it (they) may be determined dynamically by the color transformer 10 whenever a new characterization matrix is used.

In some embodiments, the color transformer 10 applies the companding function to one or more of the product terms individually and then derives at least one of the output color component values from the companded results.

In some of these embodiments, for each of the pixels, the color transformer 10 maps one of the product values (m_{gh}·cₕ) to a companded product value (y(m_{gh}·cₕ)) in accordance with the companding function, where h has an index value identifying the particular input color component g has an index value identifying a respective one of the output color components, and the values c_{g}′ of the particular output color component g are derived in accordance with equation (4):

c_{g}′=y(m_{gh}·cₕ)+Σ_{∀j≠h}m_{gi}·cⱼ. (4)

For example, in the case in which the diagonal m₂₂ element of the matrix M has the largest magnitude and is disproportionately larger than the magnitudes of the other diagonal matrix elements (e.g., by factor of two or greater), the color transformer 10 derives the output color component values from the product terms in accordance with equation (5):

$$( \begin{matrix}{m}_{11} \cdot {c}_{1} + {m}_{21} \cdot {c}_{2} + {m}_{13} \cdot {c}_{3} \\ {m}_{21} \cdot {c}_{1} + y ( {m}_{22} \cdot {c}_{2} ) + {m}_{23} \cdot {c}_{3} \\ {m}_{31} \cdot {c}_{1} + {m}_{32} \cdot {c}_{2} + {m}_{33} \cdot {c}_{3}\end{matrix} ) = ( \begin{matrix}{m}_{1}^{T} {c}^{->} \\ {m}_{2}^{T} {c}^{->} \\ {m}_{3}^{T} {c}^{->}\end{matrix} ) = ( \begin{matrix}{c}_{1}^{′} \\ {c}_{2}^{′} \\ {c}_{3}^{′}\end{matrix} ) \qquad ( 5 )$$

where mᵢ^{T}=(mᵢ₁ mᵢ₂ mᵢ₃), ĉ=(c₁ c₂ c₃)^{T}, the superscript T represents the transpose of the associated matrix, and y(x) is defined in equation (1).

In another example, the diagonal matrix elements m₁₁ and m₃₃ both have disproportionately large magnitudes in relation to the central diagonal matrix element m₂₂. In this case, the color transformer 10 derives the output color component values from the product terms in accordance with equation (6):

$$( \begin{matrix}y ( {m}_{11} \cdot {c}_{1} ) + {m}_{21} \cdot {c}_{2} + {m}_{13} \cdot {c}_{3} \\ {m}_{21} \cdot {c}_{1} + {m}_{22} \cdot {c}_{2} + {m}_{23} \cdot {c}_{3} \\ {m}_{31} \cdot {c}_{1} + {m}_{32} \cdot {c}_{2} + y ( {m}_{33} \cdot {c}_{3} )\end{matrix} ) = ( \begin{matrix}{m}_{1}^{T} {c}^{->} \\ {m}_{2}^{T} {c}^{->} \\ {m}_{3}^{T} {c}^{->}\end{matrix} ) = ( \begin{matrix}{c}_{1}^{′} \\ {c}_{2}^{′} \\ {c}_{3}^{′}\end{matrix} ) \qquad ( 6 )$$

where mᵢ^{T}=(mᵢ₁ mᵢ₂ mᵢ₃), \vec{c}=(c₁ c₂ c₃)^{T}, the superscript T represents the transpose of the associated matrix, and y(x) is defined in equation (1), and an arrow is used in the notation \vec{c} for the purpose of distinguishing the vector from its components.

In other embodiments, the color transformer 10 applies the companding function to at least one set of multiple ones of the product terms and then derives at least one of the output color component values from the companded results.

In some of these embodiments, for each of the pixels, the color transformer maps a vector of the product values m_{g}^{T}\vec{c} to a companded vector value (f(m_{g}^{T}\vec{c})) in accordance with the companding function defined in equation (7), where g has an index value identifying a respective one of the input color components. In this process, the color transformer 10 derives the values c_{g}′ of the particular output color component g in accordance with c_{g}′=f(m_{g}^{T}\vec{c}), where

$$f ( {m}_{g}^{T} {c}^{->} ) = \{ \begin{matrix}{D}_{c} ‖ {c}^{->} ‖ = {m}_{g}^{T} {c}^{->} & if {D}_{c} ‖ {c}^{->} ‖ < {z}_{0} \\ {( \frac{( ‖ {c}^{->} ‖ + p )}{‖ {c}_{max} ‖ + p} )}^{θ} & otherwise ,\end{matrix} \qquad ( 7 )$$

where p and θ are constants that depend on the color \vec{c}, where \vec{c}={cⱼ}∀j, ∥\vec{c}∥ is a norm (e.g., the Euclidean norm) of \vec{c}, cₘₐₓ is a maximal norm color (a color that just reaches the upper limit of its range) in the direction of \vec{c}, D_{c} is the directional derivative in the direction of \vec{c}, and z₀ is a threshold value. The companding function defined in equation (7) softly compands the colors near the gamut boundary. In some embodiments, the computation defined in equation (7) is optimized by precomputing the resource intensive computations involved in determining θ, cₘₐₓ, and the color norm ∥\vec{c}∥, and storing the precomputed values in small (one-dimensional) lookup tables.

In a first example in which the diagonal m₂₂ element of the matrix M has the largest magnitude and is disproportionately larger than the magnitudes of the other diagonal matrix elements (e.g., by factor of two or greater), the color transformer 10 derives the output color component values from the product terms in accordance with equations (8) and (9):

$$\begin{matrix}( \begin{matrix}{m}_{11} & {m}_{21} & {m}_{13} \\ {m}_{21} & {m}_{22} & {m}_{23} \\ {m}_{31} & {m}_{32} & {m}_{33}\end{matrix} ) ( \begin{matrix}{c}_{1} \\ {c}_{2} \\ {c}_{3}\end{matrix} ) = ( \begin{matrix}{m}_{1}^{T} {c}^{->} \\ {m}_{2}^{T} {c}^{->} \\ {m}_{3}^{T} {c}^{->}\end{matrix} ) , and & ( 8 ) \\ ( \begin{matrix}{m}_{1}^{T} {c}^{->} \\ f ( {m}_{2}^{T} {c}^{->} ) \\ {m}_{3}^{T} {c}^{->}\end{matrix} ) = ( \begin{matrix}{c}_{1}^{′} \\ {c}_{2}^{′} \\ {c}_{3}^{′}\end{matrix} ) . & ( 9 )\end{matrix}$$

In a second example, the diagonal matrix elements m₁₁ and m₃₃ both have disproportionately large magnitudes in relation to the central diagonal matrix element m₂₂. In this case, the color transformer 10 derives the output color component values from the product terms in accordance with equations (8) and (10):

$$( \begin{matrix}f ( {m}_{1}^{T} {c}^{->} ) \\ {m}_{2}^{T} {c}^{->} \\ f ( {m}_{3}^{T} {c}^{->} )\end{matrix} ) = ( \begin{matrix}{c}_{1}^{′} \\ {c}_{2}^{′} \\ {c}_{3}^{′}\end{matrix} ) . \qquad ( 10 )$$

In some embodiments, the companding operations described above are performed independently per color component. Alternatively, the companding operations are applied to all of the color components by applying the same minimum gain factor to all the color components, which adjusts the output colors towards black. The tradeoffs are darker but more accurate color tones when adjusting towards back, and somewhat less accurate color tones but brigher ones when adjusting the colors independently per component.

### IV. EXEMPLARY OPERATING ENVIRONMENTS

In general, the color transformer 10 typically includes one or more discrete data processing components, each of which may be in the form of any one of various commercially available data processing chips. In some implementations, the color transformer 10 is embedded in the hardware of any one of a wide variety of digital and analog electronic devices, including desktop and workstation computers, digital still image cameras, digital video cameras, printers, scanners, and portable electronic devices (e.g., mobile phones, laptop and notebook computers, and personal digital assistants). In some embodiments, the color transformer 10 executes process instructions (e.g., machine-readable code, such as computer software) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

Embodiments of the color transformer 10 may be implemented by one or more discrete modules (or data processing components) that are not limited to any particular hardware or software configuration, but rather it may be implemented in any computing or processing environment, including in digital electronic circuitry or in computer hardware, firmware, device driver, or software. In some embodiments, the functionalities of the modules are combined into a single data processing component. In some embodiments, the respective functionalities of each of one or more of the modules are performed by a respective set of multiple data processing components. The various modules of the color transformer 10 may be co-located on a single apparatus or they may be distributed across multiple apparatus; if distributed across multiple apparatus, the modules may communicate with each other over local wired or wireless connections, or they may communicate over global network connections (e.g., communications over the internet).

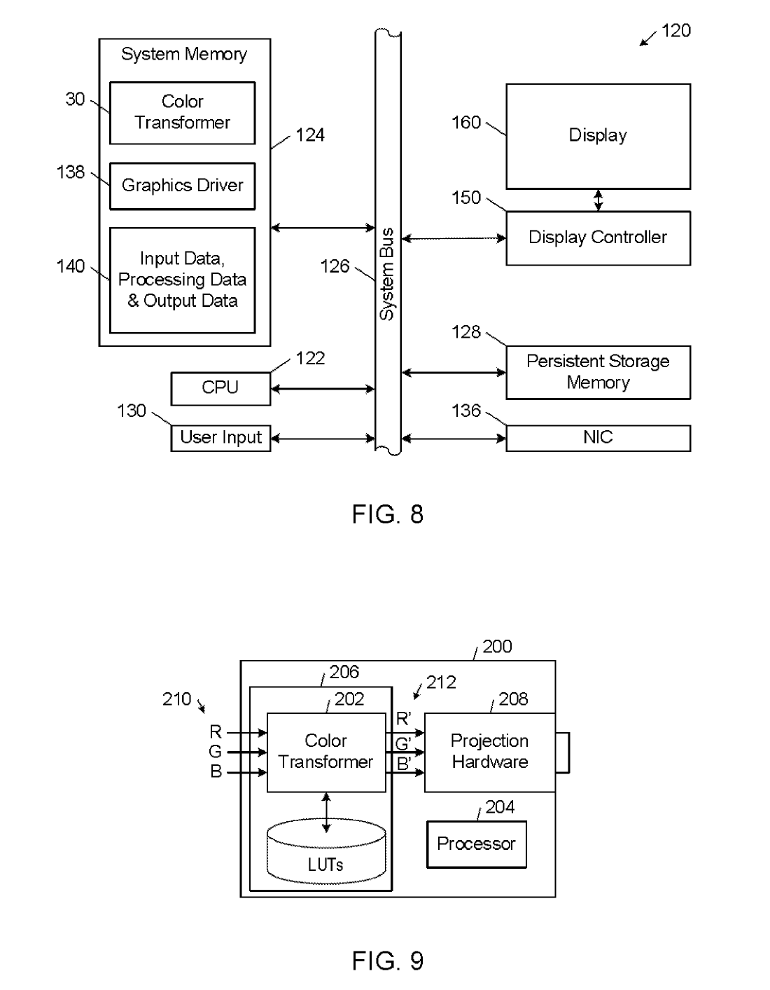

FIG. 8 shows an embodiment of a computer system 120 that can implement any of the embodiments of the color transformer 10 that are described herein. The computer system 120 includes a processing unit 122 (CPU), a system memory 124, and a system bus 126 that couples processing unit 122 to the various components of the computer system 120. The processing unit 122 typically includes one or more processors, each of which may be in the form of any one of various commercially available processors. The system memory 124 typically includes a read only memory (ROM) that stores a basic input/output system (BIOS) that contains start-up routines for the computer system 120 and a random access memory (RAM). The system bus 126 may be a memory bus, a peripheral bus or a local bus, and may be compatible with any of a variety of bus protocols, including PCI, VESA, Microchannel, ISA, and EISA. The computer system 120 also includes a persistent storage memory 128 (e.g., a hard drive, a floppy drive, a CD ROM drive, magnetic tape drives, flash memory devices, and digital video disks) that is connected to the system bus 126 and contains one or more computer-readable media disks that provide non-volatile or persistent storage for data, data structures and computer-executable instructions.

A user may interact (e.g., enter commands or data) with the computer 120 using one or more input devices 130 (e.g., a keyboard, a computer mouse, a microphone, joystick, and touch pad). Information may be presented through a user interface that is displayed to the user on a display monitor 160, which is controlled by a display controller 150 (implemented by, e.g., a video graphics card). The computer system 120 also typically includes peripheral output devices, such as speakers and a printer. One or more remote computers may be connected to the computer system 120 through a network interface card (NIC) 136.

As shown in FIG. 8, the system memory 124 also stores the color transformer 10, a graphics driver 138, and processing information 140 that includes input data, processing data, and output data. In some embodiments, the image processing system 14 interfaces with the graphics driver 138 (e.g., via a DirectX® component of a Microsoft Windows® operating system) to present a user interface on the display monitor 160 for managing and controlling the operation of the color transformer 10.

FIG. 9 shows an embodiment of a light projection system 200 that incorporates an embodiment 202 of the color transformer 10. The light projection system includes a processor 204, a processor-readable memory 206, and projection hardware 208. The projection hardware 208 includes image projection components, including a light source, which may be implemented by a wide variety of different types of light sources. Exemplary light sources include strongly colored incandescent light projectors with vertical slit filters, laser beam apparatus with spinning mirrors, LEDs, and computer-controlled light projectors (e.g., LCD-based projectors or DLP-based projectors). In the illustrated embodiments, the light projector system 60 is a computer-controlled light projector that allows the projected light patterns to be dynamically altered using computer software, which transmits input color component values 210 in a first RGB color space to the light projection system 200. The color transformer 202 transforms the input color component values 210 to output color component values 212 in a second RGB color space, and transmits the output color component values 212 to the projection hardware 208. The projection hardware renders RGB light in accordance with the output color component values 212.

### V. CONCLUSION

The embodiments that are described herein provide systems and methods of transforming from an input device-dependent color space to an output device-dependent color space. Some embodiments are designed to efficiently provide smooth transformations even when the transformation involves substantial rebalancing of the color primaries that otherwise would result in many extremely out of range colors without requiring significant memory and computational resources. Due to their efficient use of processing and memory resources, some of these embodiments may be implemented with relatively small and inexpensive components that have modest processing power and modest memory capacity.

Other embodiments are within the scope of the claims.

1. A method, comprising operating a processor to perform operations comprising:
for each of multiple pixels of an image, transforming values of input color components of the pixel in an input device-dependent color space to value of output color components in an output device-dependent color space characterized by an output color gamut defined by a respective gamut range for each of the output color components,
wherein the transforming comprises multiplying the input color component values of the pixel with corresponding elements of a device-dependent characterization matrix to produce a set of product values, deriving the output color component values from the product values, and the determining comprises ascertaining the values of a particular one of the output color components based on a continuous nonlinear companding function that maps a function input value derived from one or more of the product values to a function output value that increases monotonically with increasing function input values over the respective gamut range of the particular output color component.

2. The method of claim 1, wherein the companding function comprises a linear mapping portion that maps function input values ranging from a minimal value of the respective gamut range of the particular output color component to a threshold value to respective output values in accordance with a linear function, and a nonlinear mapping portion that maps function input values ranging from the threshold value to a maximal value of the respective gamut range of the particular output color component in accordance with a nonlinear function.

3. The method of claim 2, wherein the linear portion maps the function input values (x) less than the threshold value (x₀) to the function output values (y(x)) in accordance with y(x)=ax+b, the nonlinear portion maps the function input values greater than the threshold to the function output values in accordance with
$$y ( x ) = \frac{{( x + k )}^{γ}}{( 1 + k )} ,$$
wherein a, b, k, and γ are constants, and a, k, and γ are greater than zero.

4. The method of claim 1, wherein the characterization matrix comprises matrix elements mᵢⱼ, has values that index the input color components, i has values that index the output color components, the product values are given by mᵢⱼ·cⱼ for all {i,j}, cⱼ are the input color component values, and cᵢ′ are the output color component values.

5. The method of claim 4, wherein the ascertaining comprises for each of the pixels mapping one of the product values (m_{gh}·cₕ) to a companded product value (y(m_{gh}·cₕ)) in accordance with the companding function, h has an index value identifying the particular input color component, g has an index value identifying a respective one of the output color components, and the deriving comprises deriving the values c_{g}′ of the particular output color component g in accordance with
c_{g}′=y(m_{gh}·cₕ)+Σ_{∀j≠h}m_{gj}·cⱼ.

6. The method of claim 4, wherein the ascertaining comprises for each of the pixels mapping a vector of the product values m_{g}^{T}\vec{c} to a companded vector value (f(m_{g}^{T}\vec{c})) in accordance with the companding function, g has an index value identifying a respective one of the input color components, and the deriving comprises deriving the values c_{g}′ of the particular output color component g in accordance with c_{g}′=f(m_{g}^{T}\vec{c}),
$$f ( {m}_{g}^{T} {c}^{->} ) = \{ \begin{matrix}{D}_{c} ‖ {c}^{->} ‖ = {m}_{g}^{T} {c}^{->} & if {D}_{c} ‖ {c}^{->} ‖ < {z}_{0} \\ {( \frac{( ‖ {c}^{->} ‖ + p )}{‖ {c}_{max} ‖ + p} )}^{θ} & otherwise ,\end{matrix}$$
p and θ are constants, \vec{c}={cⱼ}∀j, ∥\vec{c}∥ is a norm of \vec{c}, cₘₐₓ is a maximal norm color in the direction of \vec{c}, D_{c} is the directional derivative in the direction of \vec{c}, and z₀ has a threshold value.

7. The method of claim 6, further comprising precomputing values of θ, cₘₐₓ, and the color norm ∥\vec{c}∥, and storing the precomputed values in at least one lookup table.

8. The method of claim 1, wherein the particular output color component is the output color component whose values are derived from one of the elements of the characterization matrix having a maximal magnitude.

9. The method of claim 1, wherein one or more larger ones of the elements of the characterization matrix are larger in magnitude than other ones of the elements by a factor of at least two, and the particular output color component is the output color component whose values are derived from at least one of the larger elements of the characterization matrix.

10. The method of claim 8, further comprising comparing the elements of the characterization matrix to one another, identifying at least one of the larger ones of the elements based on the comparison, and selecting one of the output color components as the particular output color component based on the identified larger element of the characterization matrix.

11. The method of claim 1, further comprising rendering an output image based on the output color components.

12. At least one computer-readable medium having computer-readable program code embodied therein, the computer-readable program code adapted to be executed by a computer to implement a method comprising:
for each of multiple pixels of an image, transforming values of input color components of the pixel in an input device-dependent color space to values of output color components in an output device-dependent color space characterized by an output color gamut defined by a respective gamut range for each of the output color components,
wherein the transforming comprises multiplying the input color component values of the pixel with corresponding elements of a device-dependent characterization matrix to produce a set of product values, deriving the output color component values from the product values, and the determining comprises ascertaining the values of a particular one of the output color components based on a continuous nonlinear companding function that maps a function input value derived from one or more of the product values to a function output value that increases monotonically with increasing function input values over the respective gamut range of the particular output color component.

13. The at least one computer-readable medium of claim 12, wherein the companding function comprises a linear mapping portion that maps function input values ranging from a minimal value of the respective gamut range of the particular output color component to a threshold value to respective output values in accordance with a linear function, and a nonlinear mapping portion that maps function input values ranging from the threshold value to a maximal value of the respective gamut range of the particular output color component in accordance with a nonlinear function.

14. The at least one computer-readable medium of claim 13, wherein the linear portion maps the function input values (x) less than the threshold value (x₀) to the function output values (y(x)) in accordance with y(x)=ax+b, the nonlinear portion maps the function input values greater than the threshold to the function output values in accordance with
$$y ( x ) = \frac{{( x + k )}^{γ}}{( 1 + k )} ,$$
wherein a, b, k, and γ are constants, and a, k, and γ are greater than zero.

15. The at least one computer-readable medium of claim 12, wherein the characterization matrix comprises matrix elements mᵢⱼ, j has values that index the input color components, i has values that index the output color components, the product values are given by mᵢⱼ·cⱼ for all {i,j}, cⱼ are the input color component values, and cᵢ′ are the output color component values.

16. The at least one computer-readable medium of claim 15, wherein the ascertaining comprises for each of the pixels mapping one of the product values (m_{gh}·cₕ) to a companded product value (y(m_{gh}·cₕ)) in accordance with the companding function, h has an index value identifying the particular input color component, g has an index value identifying a respective one of the output color components, and the deriving comprises deriving the values c_{g}′ of the particular output color component g in accordance with
c_{g}′=y(m_{gh}·cₕ)+Σ_{∀j≠h}m_{gi}·cⱼ.

17. The at least one computer-readable medium of claim 15, wherein the ascertaining comprises for each of the pixels mapping a vector of the product values m_{g}^{T}\vec{c} to a companded vector value (f(m_{g}^{T}\vec{c})) in accordance with the companding function, g has an index value identifying a respective one of the input color components, and the deriving comprises deriving the values c_{g}′ of the particular output color component g in accordance with
c_{g}′=f(m_{g}^{T}\vec{c}),
$$f ( {m}_{g}^{T} {c}^{->} ) = \{ \begin{matrix}{D}_{c} ‖ {c}^{->} ‖ = {m}_{g}^{T} {c}^{->} & if {D}_{c} ‖ {c}^{->} ‖ < {z}_{0} \\ {( \frac{( ‖ {c}^{->} ‖ + p )}{‖ {c}_{max} ‖ + p} )}^{θ} & otherwise ,\end{matrix}$$
p and θ are constants, \vec{c}={cⱼ}∀j, ∥\vec{c}∥ is a norm of \vec{c}, cₘₐₓ is a maximal norm color in the direction of \vec{c}, D_{c} is the directional derivative in the direction of \vec{c}, and z₀ has a threshold value.

18. The at least one computer-readable medium of claim 12, wherein the particular output color component is the output color component whose values are derived from one of the elements of the characterization matrix having a maximal magnitude.

19. Apparatus, comprising:
a computer-readable medium storing computer-readable instructions; and
a data processing unit coupled to the memory, operable to execute the instructions, and based at least in part on the execution of the instructions operable to perform operations comprising
for each of multiple pixels of an image, transforming values of input color components of the pixel in an input device-dependent color space to values of output color components in an output device-dependent color space characterized by an output color gamut defined by a respective gamut range for each of the output color components,
wherein the transforming comprises multiplying the input color component values of the pixel with corresponding elements of a device-dependent characterization matrix to produce a set of product values, deriving the output color component values from the product values, and the determining comprises ascertaining the values of a particular one of the output color components based on a continuous nonlinear companding function that maps a function input value derived from one or more of the product values to a function output value that increases monotonically with increasing function input values over the respective gamut range of the particular output color component.

20. The apparatus of claim 19, wherein the companding function comprises a linear mapping portion that maps function input values ranging from a minimal value of the respective gamut range of the particular output color component to a threshold value to respective output values in accordance with a linear function, and a nonlinear mapping portion that maps function input values ranging from the threshold value to a maximal value of the respective gamut range of the particular output color component in accordance with a nonlinear function.
